(19) United States
(12) Patent Application Publication
(10) Pub. No.: US 2026/0359130 A1
(43) Pub. Date: Nov. 12, 2026

(54) ALLOCATING NETWORK RESOURCES TO APPLICATIONS

(71) Applicant: HUAWEI TECHNOLOGIES CO., LTD., Shenzhen (CN)

(72) Inventors: Mohammadamin Malekisadr, Toronto (CA); Hossein Shafieirad, Markham (CA); Geng Li, North York (CA)

(21) Appl. No.: 19/210,030

(22) Filed: May 16, 2025

(30) Foreign Application Priority Data
May 12, 2025 (CN) XW2025501090

(51) Int. Cl. G06F 9/50

(52) U.S. Cl. CPC G06F 9/5038

(57) ABSTRACT

Network resources are allocated to applications. In particular, requests for network resources are received from the applications. For each request, a credit score for the application that sent the request is determined based on one or more previous requests received from the application that sent the request, a priority is assigned to the request based on the credit score, and the request is transmitted to a network for execution of the request, based on the priority.

### CROSS-REFERENCE TO RELATED APPLICATION

The present application claims priority to Chinese application Serial No. XW2025501090 entitled A SYSTEM AND METHOD FOR SELFISH APPLICATION DETECTION AND FAIR RESOURCE ALLOCATION, filed on May 12, 2025, the entirety of which is herein incorporated by reference.

### FIELD

The present disclosure relates to resource management and in particular to methods and systems for allocating network resources to applications.

### BACKGROUND

Modern data center networks (DCNs) serve as the backbone of cloud computing, supporting a vast array of applications with diverse requirements, such as real-time communication, large-scale data processing, and latency-sensitive operations. Applications in these shared environments often operate with conflicting goals, ranging from high throughput to stringent latency objectives, creating significant challenges for resource management systems.

The core difficulty lies in dynamic resource allocation: ensuring fair and efficient distribution of limited bandwidth, compute, and storage resources. This challenge is compounded in multi-tenant DCNs, where multiple organizations and applications, often unaware of one another, compete for shared infrastructure.

For example, many applications overestimate their resource needs as a precautionary measure or as a competitive strategy to dominate shared resources. This results in the well-known “race-to-the-top” phenomenon, where applications escalate their requests to higher priority levels during periods of congestion. This leads to inefficient resource allocation, congestion, and unfair priority handling, ultimately degrading the overall performance for all co-located applications.

Furthermore, resource management systems often assume that applications provide accurate resource demands. In practice, this assumption fails, since the actual resource requirements can vary unpredictably due to bursty traffic patterns or real-time scaling needs, such as distributed databases or microservices.

Existing frameworks prioritize either fairness or performance. However, fairness mechanisms can inadvertently penalize critical tasks by but failing to differentiate between legitimate and inflated requests, while latency-optimized solutions often fail to ensure equitable resource distribution which can lead to resource domination by selfish applications.

With the increasing scale and complexity of modern DCNs, resource management systems must handle thousands of nodes and applications while maintaining fairness and efficiency.

Centralized architectures (e.g., Software-Defined Networking) often struggle with the computational complexity of managing dynamic and high-frequency updates in real-time.

### SUMMARY

According to a first aspect of the disclosure, there is provided a method of allocating network resources to applications, comprising: receiving, from the applications, requests for network resources; and for each request: determining, based on one or more previous requests received from the application that sent the request, a credit score for the application that sent the request; assigning, based on the credit score, a priority to the request; and transmitting, based on the priority, the request to a network for execution of the request. As a result, the race-to-the-top phenomenon may be mitigated by penalizing selfish behavior while rewarding well-behaved applications.

Determining the credit score may comprise: determining an aggregate credit score for the application; determining, based on the request, an instant credit score for the application; and determining the credit score by updating the aggregate credit score based on the instant credit score.

Each request may include one or more parameters selected from the following: an application-requested priority of the request; an amount of requested network resources; and a deadline for execution of the request. Determining the credit score may be further based on the selected one or more parameters.

Determining the credit score may comprise: determining an instant credit score for the application by calculating sₜ=1−F_{S}_{ₚ}_{, S}_{_{S}}_{, S}_{_{dl}} (s_{p,t}, s_{s,t}, s_{dl,t}), wherein sₜ is the instant credit score for the application, F is the cumulative distribution function, s_{p,t} is the application-requested priority of the request, s_{s,t} is the amount of requested network resources, and s_{dl,t} is the deadline for execution of the request; and determining the credit score by calculating crₜ=αcrₜ₋₁+(1−α)s_{c,t}, wherein crₜ is the credit score for the application, crₜ₋₁ is a previous credit score for the application, and α is a constant. crₜ may be an exponentially weighted moving average.

Assigning the priority may be furthermore based on one or both of: a length of the request; and an application-requested priority of the request.

Assigning the priority may comprise calculating:

$${pr}^{*} = pr δ log ( \frac{l ( WQE )}{l ( WQE )} ) + η {e}^{- λ cr - 1} ,$$

wherein pr′ is the priority assigned to the request, pr is the application-requested priority of the request, I(WQE) is the length of the request, cr is the credit score for the application, and δ, η, and λ are adjustable hyper-parameters.

Transmitting the request may comprise: based on the assigning priority, placing the request in a selected one of a number of different queues; and transmitting the request based on the selected queue.

Transmitting the request based on the selected queue may comprise: transmitting the request based on the selected queue and based on a number of requests remaining in the selected queue. As a result, FCT may be minimized by ensuring efficient handling of high-priority traffic without neglecting queues in which a relatively large number of pending requests are found.

Transmitting the request based on the selected queue may comprise calculating:

$${\hat{ρ}}_{i , t} = \frac{{τ}_{i} {q}_{i , t}}{{{\sum }^{n}}_{i = 1} {τ}_{i} {q}_{i , t}} {ρ}_{i , t} {∀}_{i = 1 , … , n}$$

and q_{i,k+1}=q_{i,k}+(ε_{i,k}−ρ_{i,k})Δt, wherein ρ_{i,t} is the previous number of requests that can be sent from the i^{th} queue at time t, \hat{ρ}_{i,t} is the new number of requests that can be sent from the i^{th} queue at time t, τᵢ is a priority of the i^{th} queue, q_{i,t} is a measure of how full is the i^{th} queue at time t, ε_{i,k} is the rate that requests that are being received at the i^{th} queue at time k, and Δt a time interval required for each queue to finish one round in a round robin scheduler.

The method may further comprise: detecting network congestion; and in response to detecting network congestion: receiving, from the applications, at least one further request for network resources, wherein the at least one further request includes an application-requested priority; and downgrading the application-requested priority of the at least one further request.

Downgrading the application-requested priority may comprise: transmitting a message from the network to each node in a common cluster of nodes; and for each node in the common cluster of nodes, and in response to receiving the message, downgrading the application-requested priority of each further request for network resources that has been received from each application in the node.

Transmitting the message may further comprise: transmitting the message from the network to each cluster of multiple clusters of nodes; and for each cluster in the multiple clusters, including the common cluster, transmitting the message to each node comprised in the cluster.

The method may further comprise: updating, based on the determined credit score, a low-level credit table storing a credit score for each application, from among the applications, in a common node.

The method may further compromise: updating, based on the updated low-level credit table, a high-level credit table storing a credit score for each application, from among the applications, in each node in a common cluster of nodes.

Updating the low-level credit table may comprise updating the low-level credit table according to a first update period. Updating the high-level credit table may comprise updating the high-level credit table according to a second update period that is longer than the first update period.

According to a further aspect of the disclosure, there is provided a non-transitory computer-readable storage medium storing computer program code configured, when executed by one or more processors, to cause the one or more processors to perform a method of allocating network resources to applications according to any of the above-described methods.

This summary does not necessarily describe the entire scope of all aspects. Other aspects, features, and advantages will be apparent to those of ordinary skill in the art upon review of the following description of specific embodiments.

### DRAWINGS

Embodiments of the disclosure will now be described in detail in conjunction with the accompanying drawings of which:

FIG. 1 is a schematic diagram of a system configured for allocating network resources to applications, according to an embodiment of the disclosure;

FIG. 2 is a schematic diagram of a network including multiple interconnected nodes and clusters of nodes, according to an embodiment of the disclosure;

FIG. 3 is a schematic diagram of a demand evaluation module interacting with applications transmitting requests for network resources, according to an embodiment of the disclosure;

FIG. 4 is a plot of average flow completion time (FCT) as a function of different resource management frameworks and different priorities, according to an embodiment of the disclosure;

FIG. 5 is a plot of the 99.99th percentile FCT as a function of different resource management frameworks and different priorities, according to an embodiment of the disclosure;

FIG. 6 is a plot of the percentage of requests meeting deadlines as a function of different resource management frameworks and different priorities, according to an embodiment of the disclosure;

FIG. 7 is a plot of the probability of different resource allocation strategies (including the credit-based fairness approach described herein) experiencing different FCTs, according to an embodiment of the disclosure;

FIG. 8 is a schematic diagram of a computer network system for performing resource management by allocating network resources to applications, according to an embodiment of the disclosure; and

FIG. 9 is schematic diagram showing a simplified hardware structure of a computing device of the computer network system shown in FIG. 8.

### DETAILED DESCRIPTION

The present disclosure seeks to provide novel methods and systems for allocating network resources to applications. While various embodiments of the disclosure are described below, the disclosure is not limited to these embodiments, and variations of these embodiments may fall within the scope of the disclosure which is to be limited only by the appended claims.

As described above, the shortcomings of existing resource management systems underscore the need for a solution that addresses these shortcomings. Generally, embodiments of the disclosure relate to data center resource management, and for example resource management in multi-tenant environments in which applications share limited resources such as bandwidth, storage, and compute capacity. Embodiments of the disclosure may mitigate the challenges of fair resource allocation, latency optimization, and scalability in modern DCNs.

As described above, the shortcomings of existing resource management systems underscore the need for a solution that addresses these shortcomings. Therefore, and as described in more detail herein, embodiments of the disclosure may simultaneously allow for equitable resource distribution among applications based on real-time conditions as well as the applications' historical behavior, reducing Flow Completion Time (FCT) for critical tasks without penalizing lower-priority requests. Embodiments of the disclosure further allow for a distributed and hierarchical architecture to handle the computational demands of large-scale DCNs, as well as dynamic mechanisms to mitigate over-requesting behavior and to adjust to changing network conditions.

In particular, the credit-based fairness framework described herein may integrate historical application behavior with real-time network feedback to tackle resource allocation challenges in dynamic multi-tenant environments. In the proposed framework, fairness may entail restricting an application's selfish behavior (e.g., repeated over-requesting of resources) by downgrading the priority of subsequent requests from that application as well as reducing that application's credit score, while conversely upgrading the priorities of requests from well-behaved applications, as well as increasing the credit scores of such applications. One of the goals of the architecture is to achieve the Pareto optimality in which no action taken by the applications, nor any allocation of network resources, can improve a given application's position without also simultaneously disadvantageng another application. In the proposed framework, each application only has access to its own state knowledge, meaning that each application is unaware of the actions and rewards associated with each other application.

As will be described in further detail below, the described framework addresses the shortcomings of prior solutions by integrating different mechanisms. In particular, the described framework may reward applications (for example, by assigning credit to an application) based on the application's historical consistency and accuracy of its requests for resources. This method of rewarding applications may mitigate the race-to-the-top phenomenon by penalizing selfish behavior while rewarding well-behaved applications. Furthermore, the described framework may employ an adaptive weighted fair queuing approach to dynamically adjust resource allocation based on the number of pending requests in any given queue, as well as the priority associated with that queue. This may assist in minimizing FCT, ensuring efficient handling of high-priority traffic without neglecting queues in which a relatively large number of pending requests are found. Further still, by employing a hierarchical resource allocation design as described in further detail below, the computational complexity of the framework is reduced. In particular, the computational complexity may be reduced from an exponential one to a linear one, enabling the deployment of the architecture in large-scale DCNs with thousands of nodes and applications. Furthermore, hierarchical updates at intra-node, intra-cluster, and inter-cluster levels may ensure scalability and efficiency.

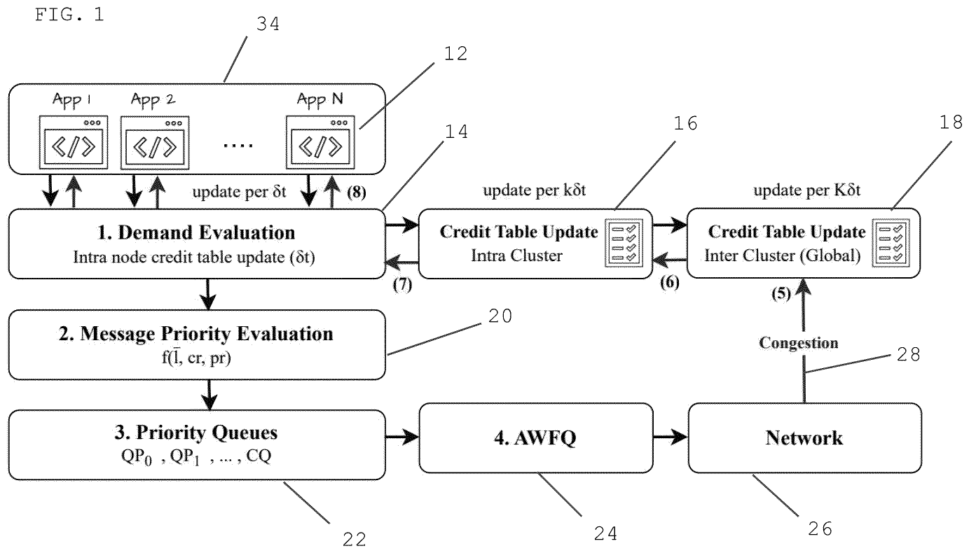

Turning first to FIG. 1, there is shown a schematic diagram of a system for allocating network resources to applications, according an embodiment of the disclosure.

As can be seen, applications 12 belonging to a common node 34 transmit requests for network resources to a demand evaluation module 14. In this case, network resources may include, for example, greater bandwidth or a lower latency path. As described in further detail below, each request includes an application-requested priority of the request (which can be referred to as a “desired priority”), an amount of requested network resources, and a deadline for completion of the request. The desired priority is a priority (e.g., low, medium, high) that the application desires to have assigned to the request. Demand evaluation module 14 evaluates each request that is received. As described in further detail below, for each request, demand evaluation module 14 determines a credit score for the application that sent the request. The credit score is based on one or more previous requests received from the application that sent the request. In particular, a current credit score for the application is adjusted based on the application's historical behavior. For example, if the application has historically consistently issued requests for reasonable resources (for example, resources that are not under-utilized), then the application may be considered well-behaved and its credit score may accordingly be increased. If, on the other hand, the application has historically often issued requests for more resources than are needed, then the application may be considered poorly-behaved and its credit score may accordingly be lowered.

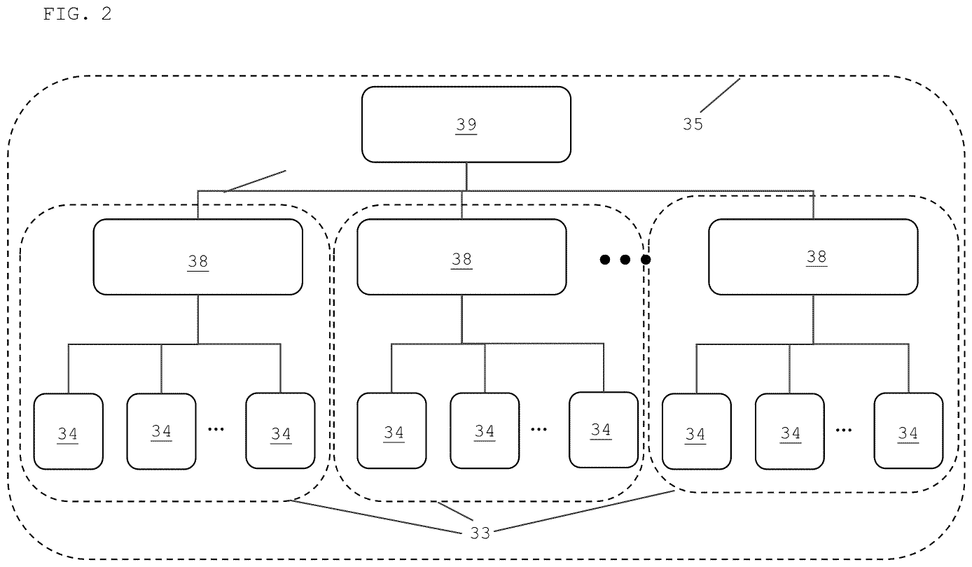

Referring to FIG. 2, there is shown a schematic diagram of a network 35 including multiple interconnected nodes 34 and clusters 33, 35 of nodes 34, according to an embodiment of the disclosure. In particular, a supercluster 35 comprises multiple interconnected clusters 33, and each cluster 33 comprises multiple interconnected nodes 34. In a given cluster 33, each node 34 is connected to a cluster head 38, and each cluster head is connected to a supercluster head 39. In this context, a node 34 may be considered to be a physical server in a datacenter that hosts multiple applications and maintains a local credit table for the applications, whereas a cluster 33 may be considered to be group of logically related nodes that maintain the intra-cluster credit table. The related nodes may be in physical proximity.

Returning to FIG. 1. the credit scores for each application 12 of a given node 34 of the network are stored in an intra-node credit table. In particular, the intra-node credit table stores a record of the current credit score of each application 12 of node 34 to which the intra-node credit table relates. Each node 34 therefore has its own demand evaluation module that stores the local credit table for the applications of that node 34. Demand evaluation module 14 updates the intra-node credit table every timestamp δt by calculating the new credit score for each application 12 of node 34. δt may be small enough to allow for credit table updates in response to each new request that is received. In addition to updating the intra-node credit table, demand evaluation module 14 also triggers updates to an intra-cluster credit table 16. Intra-cluster credit table 16 stores the intra-node credit table of each node 34 in the cluster 33. Updates to the intra-cluster credit table may occur every kδt (k>1). In addition to intra-cluster credit table 16, an inter-cluster credit table 18 is updated every Kδt (K>>k). Inter-cluster credit table 18 stores the intra-cluster credit table of each cluster 33 in the supercluster 35.

As described above, when demand evaluation module 14 receives a new request from an application 12, demand evaluation module 14 evaluates one or more parameters of the request (as described in further detail below) to assign a new credit score to application 12. After determining the new credit score, the request is passed to priority evaluation module 20. Priority evaluation module 20 is configured, based on one or more criteria, to assign a priority to the request. The assigned priority may or may not be the same priority that is desired (i.e., the “desired priority”) by the application that sent the request.

Once priority evaluation module 20 has assigned a priority to the request, the request is assigned to a priority queue from among a number of different priority queues 22. In particular, based on the evaluation performed by priority evaluation module 20, a request may be assigned a low priority, a medium priority, or a high priority (although any number of different priorities may be used). In such a case, priority queues 22 correspondingly include a low-priority queue, a medium-priority queue, and a high-priority queue, and, depending on the priority that is assigned to the request, the request is added or otherwise assigned to the respective priority queue 22.

As described in further detail below, an adaptive weighted fair queuing module 24 is then used to determine, from among the various pending requests assigned to priority queues 22, which subsequent request is to be passed to the network 26 for processing. In particular, when determining which request to pass next to network 26, adaptive weighted fair queuing module 24 may take into account the number of pending requests assigned to each priority queue 22.

Once adaptive weighted fair queuing module 24 determines the next request that is to be passed to network 26, the request is transmitted to network 26, and network 26 makes available the requested network resources to the application 12 that made the request. For the purposes of this disclosure, this step is not described in detail since it is well-understood in the art.

Depending on the loads being handled by network 26, at times network congestion 28 may be detected. Network congestion may be detected, for example, by using explicit congestion notification (ECN) signal feedback from network 26. If network congestion 28 is detected, any further request that is received at demand evaluation module 14 from applications 12 may be downgraded in priority. Downgrading a priority may comprise the application-requested priority for any subsequent request being automatically set to a lower priority. For example, if, after network congestion 28 is detected, an application 12 transmits to demand evaluation module 14 a request with a desired medium priority, demand evaluation module 14 may automatically downgrade the desired priority to a low priority.

In cases of network congestion, priorities are adjusted in a stepwise manner to maintain fairness and balance resource distribution. Specifically, in response to congestion being detected, the priorities for all new requests being received from all applications in the cluster are downgraded. For example, supercluster head 39 may send a message to each associated cluster head 38 which in turn may send a message to each associated node 34 such that the priorities for all new requests being received from all applications of the node 34 are downgraded. This hierarchical adjustment process ensures that congestion signals propagate effectively while maintaining scalability. According to some embodiments, in response to detecting network congestion 28, network 26 may instruct each individual demand evaluation module 14 to downgrade priorities, instead of using the hierarchical method described above.

Turning to FIG. 3, there is shown a schematic diagram of demand evaluation module 14 interacting with applications 12 transmitting requests for network resources, according to an embodiment of the disclosure. In particular, FIG. 3, shows intra-node level hierarchy, with each agent having two levels. In FIG. 3, the first superscripts and the subscripts respectively denote the application index and time index, and second superscripts L and H respectively denote updating a low-level or a high-level agent. A request from the i^{th} application at time step t will be evaluated based on the application's determined credit score, and as a result a state vector

$${s}_{t}^{i}$$

and reward

$$( {r}_{t}^{i} )$$

are returned to the application. The application employs action

$${a}_{t + 1}^{i}$$

at the next time step. In the context of reinforcement learning, an agent may be an entity that interacts with the environment to learn optimal behavior, the environment may be a context or state within which the agent operates, and an action may be a decision made by the agent that can alter the state of the environment.

As described above, according to some embodiments of the disclosure, there are three types of credit table updates: intra-node (i.e., node-level) credit table updates, intra-cluster (i.e., cluster-level) credit table updates, and inter-cluster (i.e., supercluster-level) credit table updates. Node-level credit updates may occur when: i) a new request is received at demand evaluation module 14; ii) processing of a request is completed by network 26; iii) there are not enough resources to meet demand (e.g., network congestion is detected); and iv) a higher-level agent undergoes a credit score update. In the context of the three “levels” of the hierarchical network described above, the intra-cluster credit table is a higher-level agent to the intra-node credit table, the intra-node credit table is a lower-level agent to the intra-cluster credit table, the inter-cluster credit table is a higher-level agent to the intra-cluster credit table, and the intra-cluster credit table is a lower-level agent to the inter-cluster credit table.

As described above, cluster-level updates take place every kδt. When a cluster-level update takes place, each node within the cluster broadcasts its node-level credit table cr^{{i,L}} to the cluster head of the cluster. The cluster head aggregates the broadcasted node-level credit tables (cr^{{i,L}}) and updates the cluster-level credit table based on the aggregated node-level credit tables.

In a similar fashion, supercluster-level updates take place every Kδt (where K>>k). When a supercluster-level update takes place, each cluster within the supercluster broadcasts its cluster-level credit table to the supercluster head of the supercluster. The supercluster head aggregates the broadcasted cluster-level credit tables and updates the supercluster-level credit table based on the aggregated cluster-level credit tables.

As described above, credit tables are updated across three levels—intra-node, intra-cluster, and inter-cluster—to reduce computational complexity and enable scalability. In order to mitigate the communications overhead for policy updates, the framework described herein may employ a hierarchical communication structure in which applications in the same node or in the same cluster have their associated credit table updated together. As described above, when considering node-level updates, the intra-node credit table, rewards, and states are low-level and the intra-cluster credit table, rewards, and states are high-level. When considering cluster-level updates, the intra-node credit table, rewards, and states are low-level and the inter-cluster credit table, rewards, and states are high-level. First, the low-level agents are updated and then the high-level agents are updated. An application-aware control policy employs Hierarchical Reinforcement Learning (HRL) in a decentralized state observation manner (see FIG. 3). The HRL architecture comprises a single controller policy, several sub-policies, and a fair reward system.

Applications 12 receive their rewards through the above-described hierarchical credit tables which comprise credit scores

$${s}_{c}^{i}$$

for each application. When demand evaluation module 14 evaluates each request, demand evaluation module 14 computes a real-time credit score for the application that sent the request. Demand evaluation module 14 then evaluates each request, based on the associated real-time credit score at time t,

$${s}_{c , t}^{i} ,$$

and updates the credit table. The credit matrix M comprises information about the most recent T requests. In particular, each element of credit matrix M includes the state space observation of the corresponding application that sent the request.

According to some embodiments, the credit scores may be defined according to:

$${s}_{c , t}^{i} = 1 - {F}_{{S}_{p} , {S}_{s} , {S}_{dl} ( {s}_{\{ p , t \}}^{i} , {s}_{\{ s , t \}}^{i} , {s}_{\{ dl , t \}}^{i} )} \qquad ( 1 )$$

F_{S}_{ₚ}_{,S}_{ₛ}_{,S}_{_{dl}} stands for the multivariate Cumulative Distribution Function (CDF) of the random vector S=[Sₚ, Sₛ, S_{dl}]^{T} and is evaluated at the values

$${s}_{\{ p , t \}}^{i} , {s}_{\{ s , t \}}^{i} , and {s}_{\{ dl , t \}}^{i} .$$

Let

$${cr}_{t}^{i}$$

denote the credit score of application i at the time step t. At each update of the node-level credit table,

$${cr}_{t}^{i}$$

is updated based on historical credit scores of the application as well as the application's current credit score, as follows:

$${cr}_{t}^{i} = α {cr}_{t - 1}^{i} + ( 1 - α ) {s}_{c , t}^{i} 0 \leq t < T \qquad ( 2 )$$

where 0≤α<1 controls the relative weights of historical credit scores and the current credit score. Higher values for alpha (e.g., 0.95) may be used for applications that exhibit a history of having transmitted relatively consist requests for network resources. Lower values for alpha may be used for applications that exhibit a history of having sporadically requested network resources (i.e., that exhibit bursty workloads).

As an example, consider two applications (N¹, N²) sharing the same node resources, each starting with neutral credit scores S_{c,0}=0.5, and each having a credit history weight α=0.8. Assume that N¹ demonstrates consistent network resource requests and has currently sent a request for

$${s}_{s}^{1} = 32 KB ,$$

with a desired high priority of Pₕ=0, and a deadline for completion of

$${s}_{dl}^{1} = 5 μ s .$$

Applying equation (1), this results in F_{S}_{ₚ}_{, S}_{ₛ}_{, S}_{_{dl}} (0, 32 KB, 5 μs)=0.3. The instant credit score determined for the request is therefore cr¹=0.8×0.5+0.2×0.7=0.54. The application's credit score is therefore increased from 0.5 to 0.54.

In contrast, let us assume that N² exhibits aggressive behavior by sending a large 128 KB request with a requested high priority and a demanding 2 μs latency, resulting in F_{S}_{ₚ}_{,S}_{ₛ}_{,S}_{_{dl}} (0, 128 KB, 2 μs)=0.8 and cr²=0.8×0.5+0.2×0.2=0.44.

As a result, when these two applications compete for resources, N¹'s request is more likely to be assigned a higher priority by message priority evaluation module 20 due to its historically consistent and reasonable behavior which has resulted in a higher current credit score of 0.54 when compared to N²'s request. This example demonstrates how demand evaluation module 14 effectively rewards good behavior and penalizes over-requesting of resources.

Once demand evaluation module 14 has determined the instant credit score for the application that sent the request, message priority evaluation module 20 assigns a priority to the request. Various parameters of the request may be taken into account when determining the priority to assign to the request. According to some embodiments, (i) the size of the request, (ii) the desired priority, and (iii) the credit score determined for the application are each taken into account. Generally, the objective of message priority evaluation module 20 is to adjust the desired priority of the request to satisfy latency-sensitive requests. This adjustment takes into account the past behavior of the application, as reflected by the application's current credit score. For example, as described above, if an application has consistently sent accurate requests for resources (i.e., has not over-requested resources), then their credit score will be higher and their request is more likely to be prioritized as a result. Conversely, if an application has consistently sent inaccurate requests for resources (i.e., has over-requested resources), then their credit score will be lower and their request is less likely to be prioritized as a result. Therefore, message priority evaluation module 20 is configured to penalize poorly-behaving applications (i.e., low credit scoring applications) by downgrading the desired priority of their requests while prioritizing well-behaving applications (i.e., high credit scoring applications) by upgrading the desired priority of their requests.

According to some embodiments, the priority message priority evaluation module 20 assigns to a request may be calculated as follows. Consider the j^{th} request (i.e., “WQE”) with a desired priority i:

$${WQE}_{j}^{i} .$$

The size of the request, the desired priority, and associated credit score of the application that sent the request are respectively defined by

$${l}_{j}^{i} , {pr}_{j}^{i} , and {cr}^{i} .$$

The modified priority of

$${WQE}_{j}^{i}$$

is denoted by

$${pr}_{j}^{{i}^{*}}$$

which can be calculated using the following non-linear function:

$${pr}_{j}^{{i}^{*}} = f ( {l}_{j}^{i} , {cr}^{i} , {pr}_{j}^{i} ) = {pr}_{j}^{i} + δ log ( {κ}_{j}^{i} ) + η exp ( λ {cr}^{i} - 1 ) \qquad ( 3 )$$

δ, η, and λ are hyper-parameters that may be tuned to meet sensitive deadlines of high-priority requests.

$${κ}_{j}^{i} = \frac{ℓ ( {WQE}_{j}^{i} )}{\overline{ℓ} ( {WQE}_{j}^{i} )}$$

is the average size (over both i and j) of

$${WQE}_{j}^{i} .$$

Parameter δ controls the impact of the size of the request, parameter η weights the impact of the credit score calculated for the application that sent the request, and parameter λ controls the impact that the credit score has.

Once message priority evaluation module 20 assigns a priority to the request, the request is then assigned to a corresponding priority queue 22. For example, as described above, there may be a low-priority queue, a medium-priority queue, and a high-priority queue, and, depending on the priority that is assigned to the request, the request is added or otherwise assigned to the respective priority queue 22. An algorithm is then used to optimize recursive weights, based on the number of pending requests in each priority queue, to achieve the lowest FCT. In other words, the “size” of each priority queue (i.e., the number of pending requests in each priority queue that are waiting to be transmitted to the network) may be taken into account in order to improve the FCT. For example, if the low-priority queue has a relatively large number of pending requests, then the algorithm is more likely to use a stronger weight for the low-priority queue when determining which request to transfer next to network 26. Using fixed values for the weights may be inefficient due to the varying rate of incoming requests that are assigned to the different priority queues.

Assume that the length of the i^{th} queue at time step t is q_{i,t}. Assume that the total number of requests that can be sent through one queue at time step t for the i^{th} queue is ρ_{i,t}. The new weights have the following share of the overall throughput:

$${\hat{ρ}}_{i , t} = \frac{{τ}_{i} {q}_{i , t}}{{{\sum }^{n}}_{i = 1} {τ}_{i} {q}_{i , t}} {ρ}_{i , t} {∀}_{i = 1 , … , n} and {q}_{i , k + 1} = {q}_{i , k} + ( {ε}_{i , k} - {ρ}_{i , k} ) Δ t ,$$

where τᵢ∈(0,1] is the priority assigned to the i^{th} queue and which indicates the number of requests at the i^{th} queue that will be transmitted to network 26 in the next service round. Assuming that a round robin scheduler is used and that the time interval to finish one round for all queues is considered as δt, then the discrete time version of the remaining requests at the ith queue is written as:

q_{i,k+1}=q_{i,k}+(ε_{i,k}−ρ_{i,k})δt, ∀i=1, . . . ,n,

where ∈_{i,k} is the number of incoming requests to the i^{th} queue at time k.

As network 26 processes requests it receives, network-related key performance indicators (KPIs) may be analyzed to identify whether network congestion 28 has occurred. In the event that network congestion 28 is detected (for example, if one or more KPIs drop below preset thresholds), then as described above each supercluster head 39 sends a message indicative of the detected congestion to each cluster head 38 connected to the supercluster head 39. In response to receiving the message, each cluster head 38 then forwards the message to each node 34 connected to the cluster head 38. The demand evaluation module 14 associated with each node 34 then down-grades the desired priority of any future requests that the demand evaluation module 14 receives. According to some embodiments, instead of the message indicative of network congestion being distributed in this hierarchical fashion, the message may be sent directly to each node 34 of the network 26.

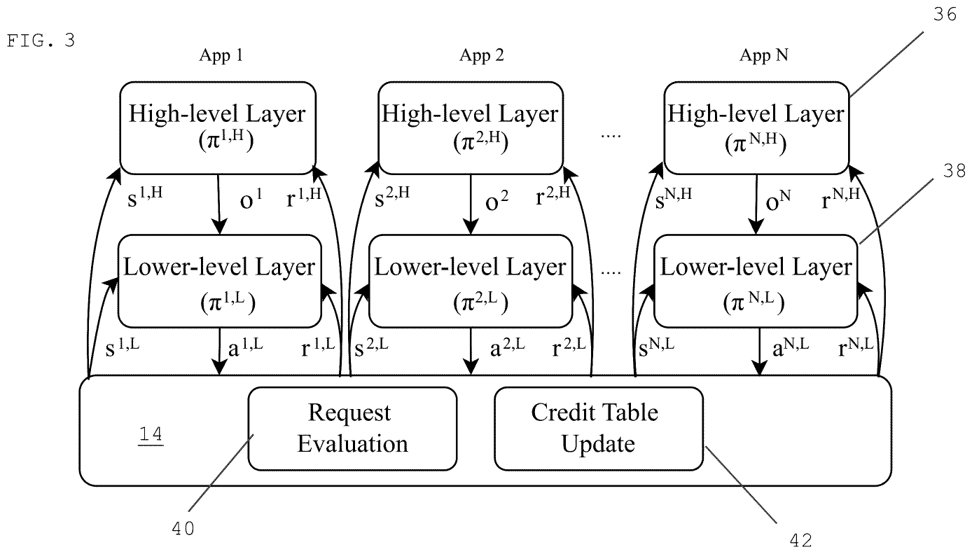

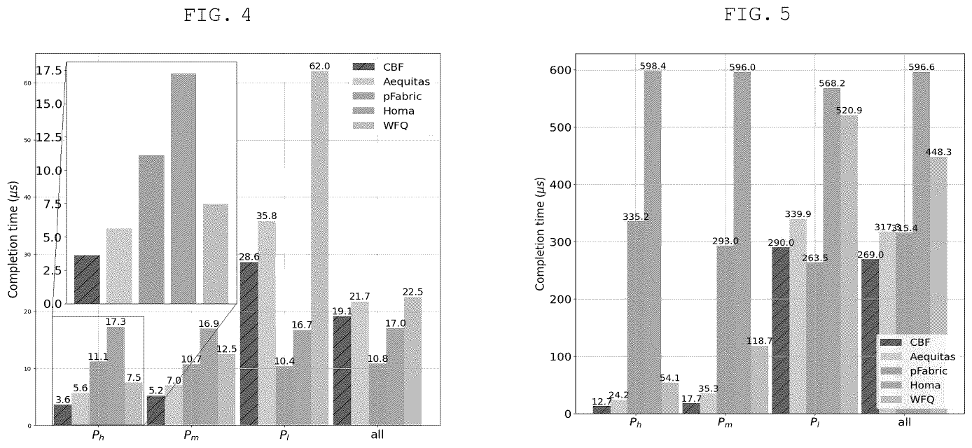

Turning to FIG. 4, there is shown the average value of FCT for different network allocation approaches and for different priorities. For high and medium priority queues (Pₕ and Pm), the credit-based approach described herein outperforms Aequitas, WFQ, Homa, and pFabric. The credit-based approach described herein improves upon Aequitas's FCT by 56% for Ph, and by 35% for Pm. While the results for the credit-based approach described herein on Pl and the overall average FCT could be improved, this is due to the model being fine-tuned to prioritize Ph and Pm traffic. However, the model's performance for overall and Pl traffic is not overly compromised. The credit-based approach described herein may be used to meet the requirements of the most critical traffic as swiftly as possible while still achieving the fastest total completion time for the most common average and burst loads in DCNs.

FIG. 5 demonstrates the 99.99^{th} percentile FCT. As seen, the credit-based approach described herein also outperforms all other approaches in terms of the 99.99^{th} percentile FCT on average. The credit-based approach described herein improves the 99.99^{th} percentile FCT for all priority queues by 17%. For Ph and Pm, the credit-based approach described herein outperforms all other approaches as well as the baseline. Comparing the results, the credit-based approach described herein outperforms Aequitas by 101% for Ph and 99% for Pm.

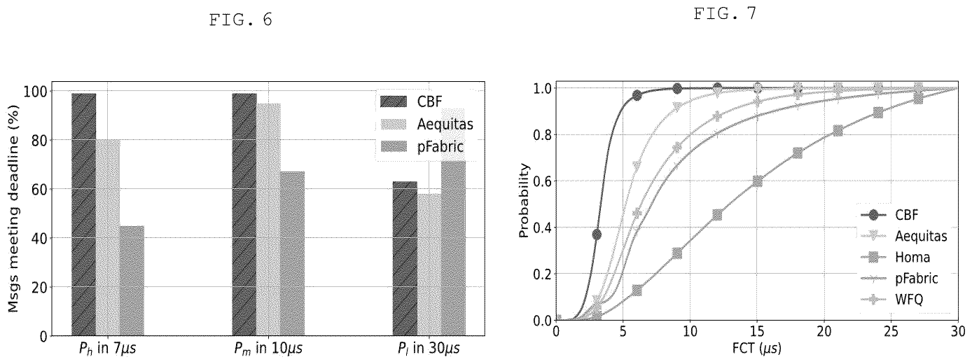

FIG. 6 shows the cumulative distribution function (CDF) of the FCTs for both selfish and unselfish applications according to different resource allocation approaches. As can be seen, the credit-based approach described herein has lower completion time for both Ph and Pm flows. As can also be seen, Ph has smaller FCTs across all methods. It is also worth noting that the number of messages served in priority queues Ph, Pm, and Pl for the credit-based approach described herein are approximately 6,000, 13,000, and 36,000, respectively. The average message size served for Ph, Pm, and Pl are 19.88 KB, 28.84 KB, and 36.84 KB, respectively.

FIG. 7 illustrates that the credit-based approach described herein may achieve the 99.99^{th} percentile FCT much more quickly than other methods for Ph, Pm, and all traffic types, which may ensure its effectiveness across varying network conditions.

FIGS. 4-7 demonstrate that the credit-based approach described herein, which leverages both credit score and WQEs priority systems, outperforms conventional methods that rely solely on regular queuing or other application-aware bandwidth allocation mechanisms. The advantages are clearly reflected in the improvements in FCT and deadline satisfaction rates, showcasing the significant impact of the credit-based approach described herein on network resource allocation.

As can be seen, using the resource management framework described herein, FCT may be reduced by up to 56% when compared to a prior art solution, and reduces the worst-case (99.99^{th} percentile) FCT for high-priority tasks by up to 17%. Furthermore, using the resource management framework described herein, deadline satisfaction may be improved by up to 19% for selfish applications and up to 16% for unselfish applications. Furthermore, using the resource management framework described herein, a credit-based fairness score of 0.9 may be achieved.

The framework described herein leverage the inherent nature of HRL to reduce the complexity of resource allocation in DCNs. The HRL system reduces complexity by dividing the state-action space into two levels: high-level agents that handle high-level credit table updates, and low-level agents responsible for managing low-level credit table updates. Low-level agents adjust in real-time to changes in application demand, ensuring fairness through the credit score mechanism.

In a flat reinforcement learning (RL) system, the total complexity grows exponentially with the number of agents due to the multiplication of their respective state and action spaces. In contrast, HRL reduces this complexity by decomposing the problem into high-level and low-level agents, leading to linear growth for both the state and action spaces. In flat RL, the total complexity of both the state and action spaces for N agents is given by the product of their individual state and action spaces:

$$\vert {𝒞}_{RL} \vert = \vert 𝒮 \vert \times \vert A \vert = {\prod }_{i = 1}^{N} \vert {𝒮}^{i} \vert \times {\prod }_{i = 1}^{N} \vert {A}^{i} \vert$$

This results in exponential growth in the total complexity as the number of agents increases, making it computationally infeasible for large systems. In contrast, in HRL, the complexity is split between a high-level agent and multiple low-level agents. The total complexity is the sum of the high-level state-action space and the sum of the individual low-level state-action spaces. The total complexity for HRL is given by:

$$\vert {𝒞}_{HRL} \vert = ( \vert {𝒮}^{H} \vert + {\sum }_{i = 1}^{N} \vert {𝒮}^{i , L} \vert ) \times ( \vert {A}^{H} \vert + {\sum }_{i = 1}^{N} \vert {A}^{i , L} \vert )$$

where S^{H}, S^{i,L}, A^{H}, A^{i,L}, respectively, are the state space of the high-level agents, the state space of the ith low-level agent, the action space of high-level agents, and the action space of ith low-level agent. By reducing the action and state space complexity from exponential growth to linear growth, HRL significantly lowers the computational cost. This reduction enables faster convergence and makes the system scalable for large-scale DCNs, and it has been shown allows the resource management framework described herein to handle over 1,000 agents.

As the network size and the number of applications increase, the system should be able to maintain its performance and fairness guarantees without introducing significant overhead. To address this, and as described above, the framework described herein employs a distributed architecture where each node maintains a local credit table and policy evaluation for applications residing on that node (i.e., a low-level agent policy or intra-node policy). For M applications and N nodes, each node is only required to store information relevant to its local applications. The complexity for storing a credit matrix is O(M) per node, resulting in a total space complexity of O(MN) across the network. However, this is distributed across all nodes, with each node only needing to store information relevant to its local applications.

As described above, the framework's credit-based system scales linearly with the number of applications, as each application's credit score is computed independently. As the network grows, the credit computation remains a local operation (on a per-node basis), ensuring that the system can handle increasing numbers of nodes without centralized bottlenecks. This allows the system to leverage collective experiences while maintaining local decision-making capabilities. In the event of failure in any node, recovery may follow a three-phase protocol, as follows:
Phase 1: (i) identify the failed node(s); (ii) identify the affected states; and (iii) initiate recovery.
Phase 2: (i) obtain surviving replicas of credit tables; (ii) reconstruct the states; and (iii) verify state consistency.
Phase 3: state redistribution of the credit tables.

Malicious applications may try to manipulate the credit-based approach described herein by strategically alternating between good conduct during low-demand periods and resource exploitation during periods of peak demand, thereby maintaining an acceptable average credit score while gaining unfair advantages. These manipulations may be mitigated by using an exponentially weighted moving average mechanism (e.g., α= [0.8,0.99]) in equation (1) that heavily weights the historical behavior of the application, making it difficult to quickly gain or exploit the system through short-term behavioral changes.

The framework described herein may be integrated seamlessly with commodity DCNs through priority queue management and credit-state distribution, leveraging existing protocols for minimal disruption. The control plane may use open flow-based credit controllers to map credit-weighted priorities to hardware queue assignments in network switches. Each switch may maintain local credit states, synchronized through batched updates via standard control channels, ensuring minimal control overhead. Hierarchical credit updates occur at different timescales (δt, kδt, Kδt), limiting control overhead to less than 1% of link bandwidth.

In the data plane, switches may implement credit-based forwarding using three standard priority queues (Pₕ, Pₘ, Pₗ). Credit scores may be transmitted through existing remote direct memory access (RDMA) congestion notification channels and encoded using 2 bits in standard explicit congestion notification (ECN) or packet header fields, ensuring backward compatibility. Applications may receive credit updates via conventional socket interfaces or RDMA verbs, allowing adaptive adjustments based on behavior. When new applications join, they may be initialized with a neutral credit score (e.g., 0.5) which is gradually adjusted through hierarchical updates.

For clock synchronization, Precision Time Protocol (PTP) may be used with sub-microsecond temporal alignment. Synchronization may maintain a 50 ns error budget, ensuring deterministic time-base coherence across distributed credit evaluation nodes.

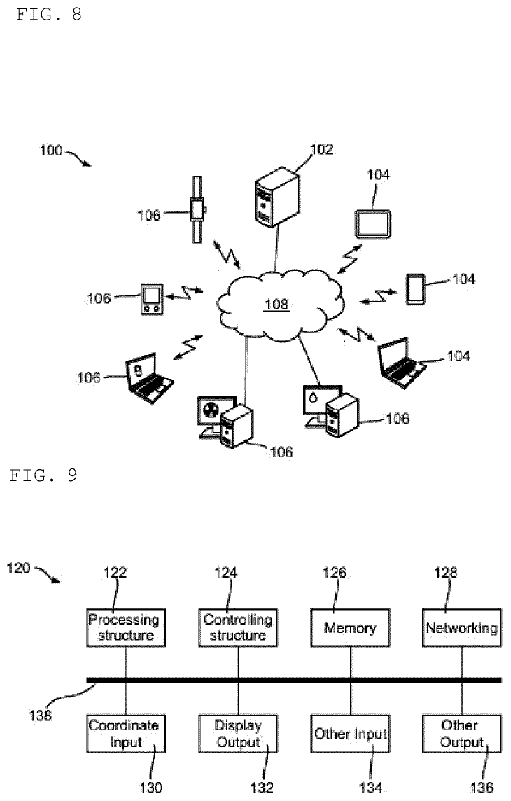

Turning now to FIG. 8, a computer network system for managing network resource allocation is shown and is generally identified using reference numeral 100. As shown, the computer network system 100 comprises one or more server computers 102 and a plurality of client computing devices 104 functionally interconnected by a network 108, such as the Internet, a local area network (LAN), a wide area network (WAN), a metropolitan area network (MAN), and/or the like, via suitable wired and/or wireless networking connections.

The server computers 102 may be computing devices designed specifically for use as a server, and/or general-purpose computing devices acting as server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

Generally, the computing devices 102 and 104 have a similar hardware structure such as a hardware structure shown in FIG. 9. As shown, the computing device 102/104 comprises a processing structure 122, a controlling structure 124, one or more non-transitory computer-readable memory or storage devices 126, a network interface 128, an input interface 130, and an output interface 132, functionally interconnected by a system bus 138. The computing device 102/104 may also comprise other components 134 coupled to the system bus 138.

The processing structure 122 may be one or more single-core or multiple-core computing processors such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), u-controllers (UCs), specialized/customized processors and/or controllers using, for example, field-programmable gate array (FPGA) or application-specific integrated circuit (ASIC) technologies, and/or the like.

Generally, each processor of the processing structure 122 comprises necessary circuitries implemented using technologies such as electrical and/or optical hardware components for executing one or more processes as the implementation purpose and/or the use case maybe, to perform various tasks.

For example, each processor of the processing structure 122 may comprise logic gates implemented by semiconductors to perform various computations, calculations, and/or processes. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processes thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation” or more generally, “processing”, for generating or producing the outputs from the inputs thereof.

Sophisticated combinations of logic gates in the form of a circuitry of logic gates, such as the one or more processors of the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed tasks. In this example, the tasks thereof are “hard-coded” in the circuitry. With the advance of technologies, it is often that a circuitry of logic gates, such as the one or more processors of the processing structure 122, may be alternatively designed in a general manner so that it may perform various tasks according to a set of “programmed” instructions implemented as firmware and/or software and stored in the memory 126 and may be executed by the one or more processors of the processing structure 122. In this example, the circuitry of logic gates, such as the one or more processors of the processing structure 122, is usually of no use without meaningful firmware and/or software.

Of course, those skilled the art will appreciate that a processor may be implemented using other technologies such as analog technologies.

The controlling structure 124 comprises one or more controlling circuits, such as graphic controllers, input/output chipsets, and the like, for coordinating operations of various hardware components and modules of the computing device 102/104.

The memory 126 comprises one or more one or more non-transitory computer-readable storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like. In use, the memory 126 is generally divided into a plurality of portions for different use purposes. For example, a portion of the memory 126 (denoted as storage memory herein) may be used for long-term data storing, for example, for storing files or databases. Another portion of the memory 126 may be used as the system memory for storing data during processing (denoted as working memory herein).

The network interface 128 comprises one or more network modules for connecting to other computing devices or networks through the network 108 by using suitable wired and/or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screens, touch-sensitive whiteboards, touch-pads, keyboards, computer mice, trackballs, microphones, scanners, cameras, and/or the like. The input interface 130 may be a physically integrated part of the computing device 102/104 (for example, the touch-pad of a laptop computer or the touch-sensitive screen of a tablet), or may be a device physically separated from but functionally coupled to, other components of the computing device 102/104 (for example, a computer mouse). The input interface 130, in some implementation, may be integrated with a display output to form a touch-sensitive screen or a touch-sensitive whiteboard.

The output interface 132 comprises one or more output modules for output data to a user. Examples of the output modules include displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or a tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement units (IMUs), and/or the like. Examples of the positioning modules may be one or more global navigation satellite system (GNSS) components (for example, one or more components for operation with the Global Positioning System (GPS) of USA, Global'naya Navigatsionnaya Sputnikovaya Sistema (GLONASS) of Russia, the Galileo positioning system of the European Union, and/or the Beidou system of China).

The system bus 138 interconnects various components 122 to 134 enabling them to transmit and receive data and control signals to and from each other.

From the computer point of view, the computing device 102/104 may comprise a plurality of modules. Herein, a “module” is a term of explanation referring to a hardware structure such as a circuitry implemented using technologies such as electrical and/or optical technologies (and with more specific examples of semiconductors) for performing defined operations or processes. A “module” may alternatively refer to the combination of a hardware structure and a software structure, wherein the hardware structure may be implemented using technologies such as electrical and/or optical technologies (and with more specific examples of semiconductors) in a general manner for performing defined operations or processes according to the software structure in the form of a set of instructions stored in one or more non-transitory, computer-readable storage devices or media.

As a part of a device, an apparatus, a system, and/or the like, a module may be coupled to or integrated with other parts of the device, apparatus, or system such that the combination thereof forms the device, apparatus, or system. Alternatively, the module may be implemented as a standalone device or apparatus.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

What is claimed is:

1. A method of allocating network resources to applications, comprising:
receiving, from the applications, requests for network resources; and
for each request:
determining, based on one or more previous requests received from the application that sent the request, a credit score for the application that sent the request;
assigning, based on the credit score, a priority to the request; and
transmitting, based on the priority, the request to a network for execution of the request.

2. The method of claim 1, wherein determining the credit score comprises:
determining an aggregate credit score for the application;
determining, based on the request, an instant credit score for the application; and
determining the credit score by updating the aggregate credit score based on the instant credit score.

3. The method of claim 1, wherein:
each request includes one or more parameters selected from the following:
an application-requested priority of the request;
an amount of requested network resources; and
a deadline for execution of the request; and
determining the credit score is further based on the selected one or more parameters.

4. The method of claim 3, wherein determining the credit score comprises:
determining an instant credit score for the application by calculating sₜ=1−F_{S}_{ₚ}_{, S}_{ₛ}_{, S}_{_{dl}} (s_{p,t}, s_{s,t}, s_{dl,t}), wherein sₜ is the instant credit score for the application, F is the cumulative distribution function, s_{p,t} is the application-requested priority of the request, s_{s,t} is the amount of requested network resources, and s_{dl,t} is the deadline for execution of the request; and
determining the credit score by calculating crₜ=αcrₜ₋₁+(1−α)s_{c,t}, wherein crₜ is the credit score for the application, crₜ₋₁ is a previous credit score for the application, and α is a constant.

5. The method of claim 4, wherein crₜ is an exponentially weighted moving average.

6. The method of claim 1, wherein assigning the priority is furthermore based on one or both of:
a length of the request; and
an application-requested priority of the request.

7. The method of claim 6, wherein assigning the priority comprises calculating:
$${pr}^{*} = pr δ log ( \frac{l ( WQE )}{l ( WQE )} ) + η {e}^{- λ cr - 1} ,$$
wherein pr* is the priority assigned to the request, pr is the application-requested priority of the request, I(WQE) is the length of the request, cr is the credit score for the application, and δ, η, and λ are adjustable hyper-parameters.

8. The method of claim 1, wherein transmitting the request comprises:
based on the assigning priority, placing the request in a selected one of a number of different queues; and
transmitting the request based on the selected queue.

9. The method of claim 8, wherein transmitting the request based on the selected queue comprises:
transmitting the request based on the selected queue and based on a number of requests remaining in the selected queue.

10. The method of claim 9, wherein transmitting the request based on the selected queue comprises calculating:
$${\hat{ρ}}_{i , t} = \frac{{τ}_{i} {q}_{i , t}}{{{\sum }^{n}}_{i = 1} {τ}_{i} {q}_{i , t}} {ρ}_{i , t} {∀}_{i = 1 , … , n} and {q}_{i , k + 1} = {q}_{i , k} + ( {ε}_{i , k} - {ρ}_{i , k} ) Δ t ,$$
wherein ρ_{i,t} is the previous number of requests that can be sent from the i^{th} queue at time t, \hat{ρ}_{i,t} is the new number of requests that can be sent from the i^{th} queue at time t, τᵢ is a priority of the i^{th} queue, q_{i,t} is a measure of how full is the i^{th} queue at time t, ε_{i,k} is the rate that requests that are being received at the i^{th} queue at time k, and Δt a time interval required for each queue to finish one round in a round robin scheduler.

11. The method of claim 1, further comprising:
detecting network congestion; and
in response to detecting network congestion:
receiving, from the applications, at least one further request for network resources, wherein the at least one further request includes an application-requested priority; and
downgrading the application-requested priority of the at least one further request.

12. The method of claim 11, wherein downgrading the application-requested priority comprises:
transmitting a message from the network to each node in a common cluster of nodes; and
for each node in the common cluster of nodes, and in response to receiving the message, downgrading the application-requested priority of each further request for network resources that has been received from each application in the node.

13. The method of claim 12, wherein transmitting the message further comprises:
transmitting the message from the network to each cluster of multiple clusters of nodes; and
for each cluster in the multiple clusters, including the common cluster, transmitting the message to each node comprised in the cluster.

14. The method of claim 1, further comprising:
updating, based on the determined credit score, a low-level credit table storing a credit score for each application, from among the applications, in a common node.

15. The method of claim 14, further comprising:
updating, based on the updated low-level credit table, a high-level credit table storing a credit score for each application, from among the applications, in each node in a common cluster of nodes.

16. The method of claim 15, wherein:
updating the low-level credit table comprises updating the low-level credit table according to a first update period; and
updating the high-level credit table comprises updating the high-level credit table according to a second update period that is longer than the first update period.

17. A computing device comprising one or more processors and memory storing instructions configured, when executed by the one or more processors, to cause the one or more processors to perform a method of allocating network resources to applications, as recited in claim 1.

18. A non-transitory computer-readable storage medium storing computer program code configured, when executed by one or more processors, to cause the one or more processors to perform a method of allocating network resources to applications, as recited in claim 1.
